(19) United States
(12) Patent Application Publication
(10) Pub. No.: US 2002/0161676 A1
(43) Pub. Date: Oct. 31, 2002

(54) PREPAID FIXED QUANTITY ACCESS TO WEB SERVICES

(76) Inventor: VISWANATH VADLAMANI, DULUTH, GA (US)

Correspondence Address: LAHIVE & COCKFIELD, 28 STATE STREET, BOSTON, MA, 02109, US

(21) Appl. No.: 09/329,710

(22) Filed: Jun. 10, 1999

(51) Int. Cl. G06F 17/60

(52) U.S. Cl. 705/30

(57) ABSTRACT

An account grants a client a prepaid fixed quantity of access to web services. The account value may be debited as the client uses the web services. The client may consume the web services until no quantity of services remains in the account. The account need not be associated with the client and may be used by multiple clients. The web services may be for the Internet, an intranet or an extranet. The account may have an associated account identifier. The account identifier may be listed on a plastic card. The client may use the plastic card as a reference when prompted to enter the account identifier to gain access to the web services.

### TECHNICAL FIELD

The present invention relates generally to computer systems and more particularly to prepaid fixed quantity access to web services.

### BACKGROUND OF THE INVENTION

Internet service providers (ISP's) require a customer to open a customer account prior to gaining access to the Internet services provided by the ISP's. A customer opens such an account by contacting an ISP via a computer connection, a telephone connection, a cable connection or a wireless connection. The customer is required to provide user identification (ID) information and to select a password. The ISP may then transmit certain data and software to be downloaded onto the customer's machine.

ISP's generally provide two types of payment schemes for customers. In the first type of payment scheme, a customer is given an unlimited quantity of access to the Internet services provided by the ISP. The customer is billed at periodic intervals, such as once a month or once a year. The customer is either sent a bill requesting payment or may be assessed a credit card charge for the costs of Internet access provided by the ISP.

In the second type of the payment scheme, a customer is charged on a per usage basis. The ISP monitors usage of the Internet services by the customer and calculates costs based upon the quantity of usage by the customer. These costs are then either billed to the customer or reflected in a credit card charge that is assessed to the customer. For example, the customer may be charged in a current month for the Internet usage in a previous month.

Such conventional ISP account and payment schemes do not work well for some customers. For example, these account and payment schemes do not work well for one time customers. A one time customer has to create an account and pay for an entire billing period of service. The account and payment schemes also do not work well for mobile customers. Mobile customers often use a number of different devices at a number of different locations. The multiple devices available to a customer may not have the requisite programs and code to access an ISP from the login site. Moreover, it may be difficult to access certain ISP's from remote locations outside a subscriber area.

### SUMMARY OF THE INVENTION

The present invention provides an approach to providing web services that is well-adapted for a variety of different users, including one-time users and multiple users. The present invention provides prepaid fixed quantity access to web services. The web services are accessed by way of accounts that have associated quantities of service. For example, an account may be allocated ten dollars worth of web access. The account has an associated account identifier and is not necessarily tied to a particular user. The user may access the Internet services until the fixed amount of web services have been consumed.

The user may be provided with the account identifier on a plastic card. The user may access a designated web page or call a designated phone number to gain access to the Internet services provided by the ISP. The user is prompted for the account identifier and, perhaps, some authentication data before the user is granted access to the Internet services.

In accordance with a first aspect of the present invention, a method is practiced in a computer network. In accordance with this method, an account is provided for access to Internet services from an ISP. The account has an associated fixed monetary value. The account is monitored to determine the quantity of usage of the account and the monetary value of the account is debited based upon the quantity of usage of the account. The account may, in some instance, not be associated with any user. A user may be refused access to the Internet services via the account when the monetary value of the account is less than a threshold amount.

In accordance with a further aspect of the present invention, a prepaid amount of web services are provided and available to a client. The client is enabled to use the web services, and the amount of web services available to the client is debited based on how much the client used the web services.

In accordance with another aspect of the present invention, a physical object that includes information regarding a prepaid amount of services from an ISP is provided to a user. A request to access the services provided by the ISP is received from the user. At least some of the information included in the physical object is received from the user, and, in response, the services are provided to the user until the prepaid amount of services have been consumed by the user.

In a distributed environment that has multiple login sites, a web services account is provided for web services. The web services account is authorized for a fixed amount of web services. A user is enabled to access the web services via an account from a first of the login sites and from a second of the login sites.

In accordance with an additional aspect of the present invention a computer system includes a web service provider for providing web services to clients. The computer system also includes an account manager for creating accounts for accessing web services provided by the web service provider. Each account is allocated a prepaid fixed amount of the web services. The computer system has a monitor for monitoring usage of the accounts and debiting accounts based on usage.

### BRIEF DESCRIPTION OF THE DRAWINGS

An illustrative embodiment, which is consistent with the principles of the present invention, will be described below relative to the following drawings.

FIG. 1 depicts a computing environment that is suitable for practicing the illustrative embodiment.

FIG. 2 depicts a block diagram of components of the client device of FIG. 1.

FIG. 3 depicts a block diagram of components of the web server of FIG. 1.

FIG. 4 depicts the format of a database that holds account information.

FIG. 5 depicts an example of an ISP card that is provided to a customer.

FIGS. 6A and 6B illustrate a smart card that may be used with the illustrative embodiment.

FIG. 7 is a flow chart depicting the steps that may be performed to receive payment for gaining access to an account for ISP services.

FIG. 8 is a flow chart that illustrates the steps performed for a client to gain access to Internet services provided by an ISP.

FIG. 9 is a flow chart illustrating the steps that are performed for a client to login to the web server of the ISP.

FIGS. 10A and 10B illustrate an example of a window that prompts a client for login information.

FIG. 11 is a flow chart illustrating steps that are performed to monitor client usage of an account.

FIG. 12 illustrates an example of a mobile user using multiple devices at multiple sites to gain access to the web servicer of an ISP.

### DETAILED DESCRIPTION OF THE INVENTION

The illustrative embodiment, which is consistent with the principles of the invention, provides prepaid Internet services. A client is provided access to a prepaid account associated with a given quantity of Internet services. In the illustrative embodiment, the account is not associated with the user. The account may be shared by multiple users. Moreover, a user may access the account from multiple login sites and from multiple machines. The value of the account is debited based upon usage.

When a client (i.e. a user) desires to access the Internet services, the client is prompted to provide an account identifier for the prepaid account. For security purposes, the client may also be prompted to provide authorization data, such as a personal identification number (PIN). The client is then granted access to the Internet services, and the usage of the Internet services by the client is monitored to continuously update the quantity of Internet services available in the account. The client may be provided with a credit card sized card that contains the account identifier and other information necessary to access the Internet services provided by the ISP.

The illustrative embodiment provides an approach to accessing Internet services that is especially well adapted for a one-time client. The one-time client need only obtain an account identifier and then use that account identifier to gain access to the ISP services. Accounts may be available in different service quantities so that a one-time client may select an account having a quantity of services that is appropriate for the anticipated usage.

The illustrative embodiment also provides a useful approach for a mobile client. The mobile client need not be concerned about which device the mobile client is using to gain access to the Internet services. Moreover, the mobile client need not be concerned with the location from which the client seeks to gain access to Internet services. The mobile client needs to simply contact a given web site or call a designated ISP telephone number to gain access to the Internet services.

In order to help clarify the discussion below, it is helpful to define a few terms.

An “Internet service provider (ISP)” provides Internet access to client.

“Web services” are services that are provided by a provider over a network, such as the Internet, an intranet or an extranet. The network may, for example, adopt the TCP/IP protocol suite.

“Internet services” are services provided by an ISP over the Internet. A primary example of Internet services is access to the Internet.

A “web server” is a server that provides web services. The web server is part of a network, such as the Internet, an intranet or an extranet.

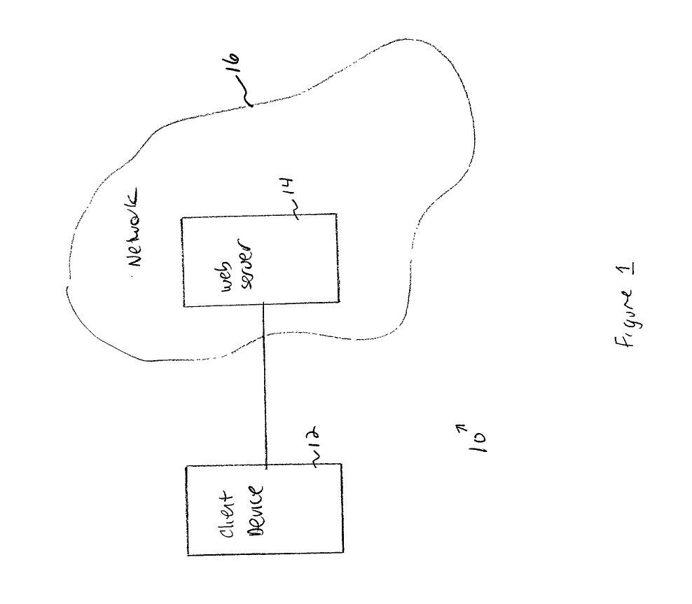

FIG. 1 depicts a computing environment 10 that is suitable for practicing the illustrative embodiment. A client uses a client device 12 to contact a web server 14 that is part of a network 16. In the illustrative embodiment, it is assumed that the web server 14 is part of the Internet. Nevertheless, those skilled in the art will appreciate that the web server 14 may also be part of an intranet, an extranet or another computer network. The present invention is not limited to being practiced within the Internet but also works with other networks and other networks that employ connectionless protocols. Moreover, in some embodiments, the client and server may reside on the same machine.

The client device 12 may be any of a number of different types of devices. For example, the client device 12 may be a desktop computer system, a laptop computer system or even a palmtop computer system. The client device 12 may be a network computer, an intelligent television set, a pager or other device that is able to communicate with the web server 14 and create an appropriate connection. The client device 12 may access the web server 14 by using a dial-up network program or by creating a connection via a web browser.

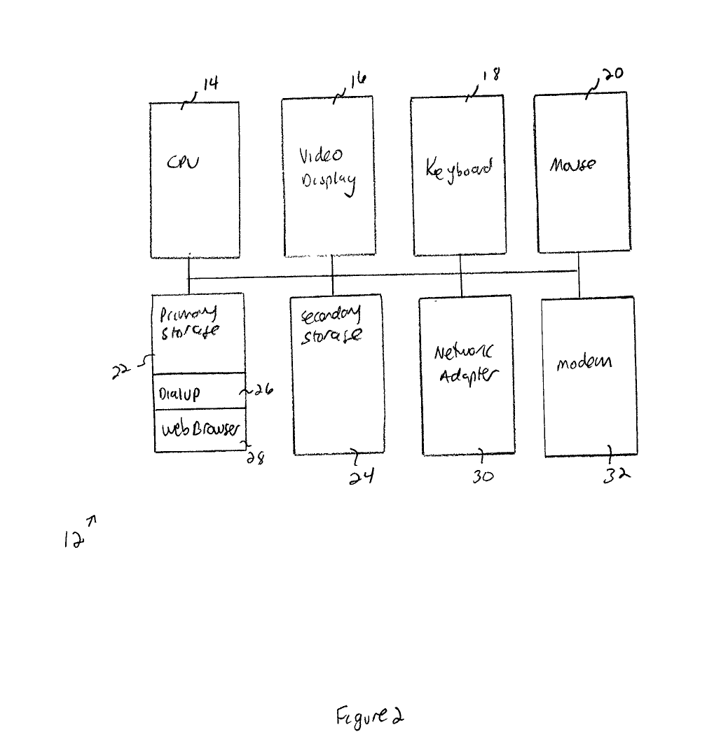

FIG. 2 depicts the client device 12 in more detail. In the example depicted in FIG. 2, the client device 12 is a computer system. The client device 12 shown in FIG. 2 includes a central processing unit (CPU) 14 for executing computer program instructions and overseeing operation of the client device. The client device 12 of FIG. 2 includes a video display 16, a keyboard 18 and a mouse 20. The client device 12 may also include a modem 32. The modem may be a conventional data modem, a cable modem or a wireless modem. A network adapter 30 may be included in the client device 12 to connect the computer system to a local area network.

The client device 12 may include primary storage 22 and secondary storage 24. The primary storage 22 and secondary storage 24 may include any of the number of well-known storage devices and computer-readable mediums. A primary storage 22 may hold dial-up networking support 26 and/or a web browser 28.

Those skilled in the art appreciate that the depiction of the client device 12 in FIG. 2 is intended to be merely illustrative and not limiting of the present invention. Configurations that differ from the configuration depicted in FIG. 2 may be utilized. For example, different peripheral devices may be utilized and not all of the components shown in FIG. 2 are required to practice the present invention.

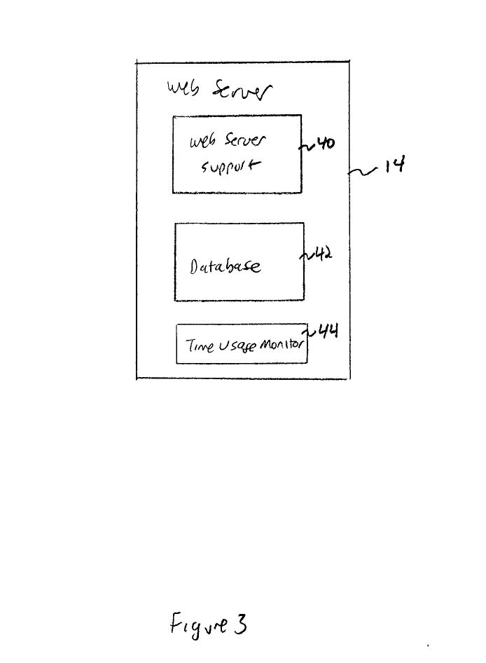

FIG. 3 depicts the major logical components of the web server 14. The web server includes web server support 40 for enabling the client to gain access to web or Internet services. The web server support 40 includes support for the TCP/IP protocol suite, HTML, or the Java™ platform and the like. Java is a trademark and/or a registered trademark of Sun Microsystems, Inc. in the U.S. and in other countries. The web server support 40 may include a number of HTML documents for web pages that are forwarded to clients. The web server 14 also includes a database 42 for holding account information. This database 42 will be described in more detail below. A time usage monitor 44 is provided in the web server 14 to monitor usage of the Internet services on a per account basis. This time usage monitor 44 will also be described in more detail below.

The web server 14 creates a number of different accounts. These accounts may be all associated with a fixed quantity of web services, or the accounts may be associated with different quantities of web services. For example, some accounts may be associated with ten dollars worth of services, whereas other accounts may be associated with five dollars of services. Similarly, accounts may be associated with five hours, ten hours and fifteen hours of service.

The quantity of services associated with an account may be expressed as a value of time, monetary value or other metric. Those skilled in the art will appreciate other methods may be used to quantify amounts of service or web access.

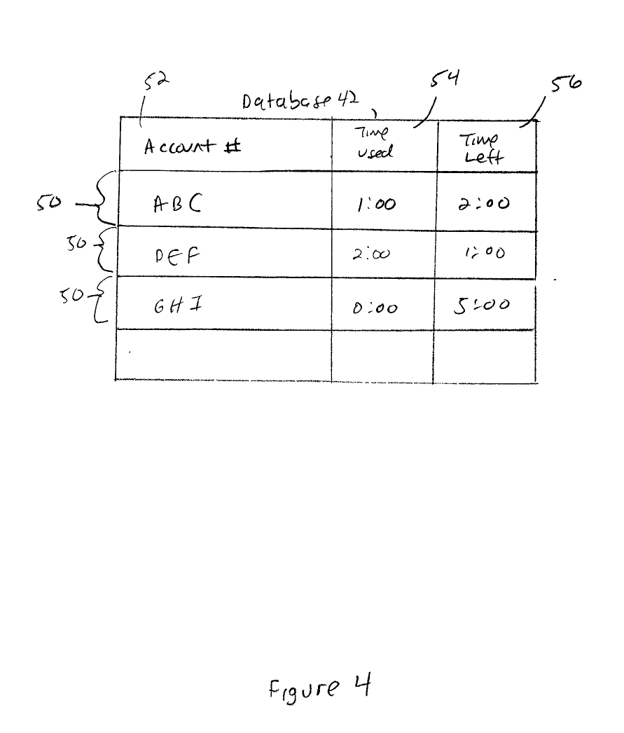

The database 42 holds information regarding each account, including the quantity of service associated with the account. FIG. 4 shows an example of the database 42. The database 42 includes an entry 50 for each account. An account number or account identifier 52 is associated with each account. The value of this account number 52 is stored within the database 42 for each account. Information regarding the time that has been consumed 54 on the account is also stored in the database. Information regarding the time that is left 56 in the account is also stored within the database 42. For example, as shown in FIG. 4, account ABC was originally allocated three hours of Internet access. An hour of the three hours has been consumed and two hours remain. Alternatively, a record of the total time purchased and the time used may be kept in the database 42. As another alternative, a record of the total time purchased and the time remaining may be kept in the database 42.

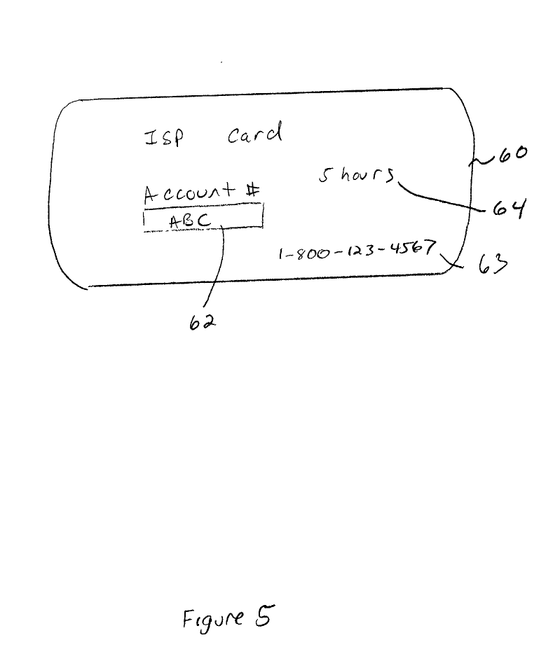

For client convenience, ISP cards, such as the ISP card 60 depicted in FIG. 5, may be utilized. These ISP cards are preferably small enough and light enough to be easily carried by a client. Preferably, the ISP card is made of a durable material, such as paper or plastic. The ISP card may contain information such as an account number of identifier 62 (e.g. “ABC”). The ISP card may also include an indicator 64 of the amount of services associated with the account. In the example depicted in FIG. 5, the ISP card is for an account that is prepaid for five hours of Internet access. The ISP card 60 may also include information 63 regarding a telephone number that is to be called to gain access to the account.

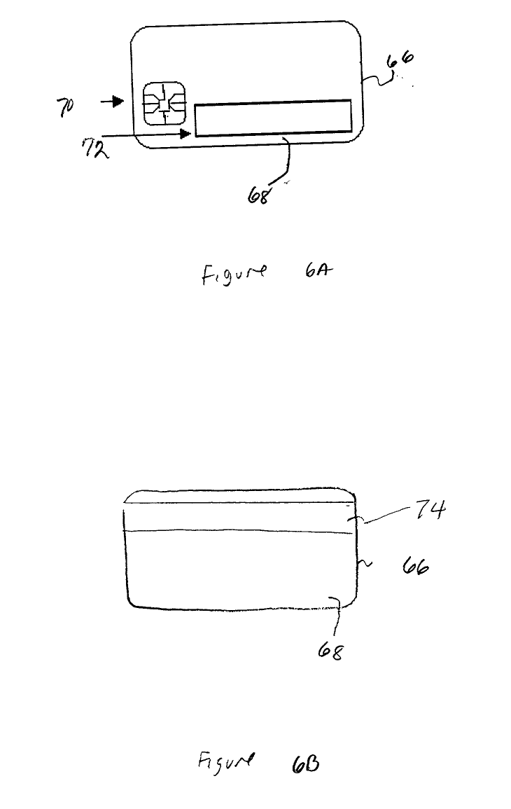

Alternatively, the user may be provided with a smart card such as shown in FIGS. 6A and 6B. The smart card may comply with the ISO-7816 standard or the EMV integrated circuit card specification. Preferably, the smart card complies with the JavaCard 2.1 specification as defined by Sun Microsystems, Inc. of Palo Alto, Calif. The JavaCard 2.1 specification requires that the secure token device be capable of running programs written in the Java programming language. Those skilled in the art will appreciate that the smart card need not run the Java programming language. Those skilled in the art will appreciate that the smart card need not run the Java programming language to practice the present invention.

FIG. 6A shows the front side of the smart card 66, that which includes a number of electrical contacts 70 for electrical communication with a microprocessor that is embedded in the smart card 66. A substrate 68 of a suitable material, such as plastic, forms the core of the smart card. A region 72 may be provided on the front side be to signed by the holder of the smart card or to hold other textual information. The smart card 66 may include a magnetic strip 74 on the rear side, such as shown in FIG. 6B, to hold information that is readable by a magnetic strip reader. The smart card may hold electronic currency tokens that are used for a payment to obtain a prepaid account on behalf of the holder of the smart card.

Payment for accounts may take many forms. A corporation may, for example, make a lump sum payment for a large number of accounts. These accounts may be distributed for promotional purposes. Moreover, these accounts may be distributed to employees of the corporation for Internet access. Still further, ISP cards may be sold in vending machines to enable a user to gain access the Internet services provided by the ISP. ISP cards may be provided for a number of different ISP's. Those skilled in the art will appreciate that a number of other payment options may be used.

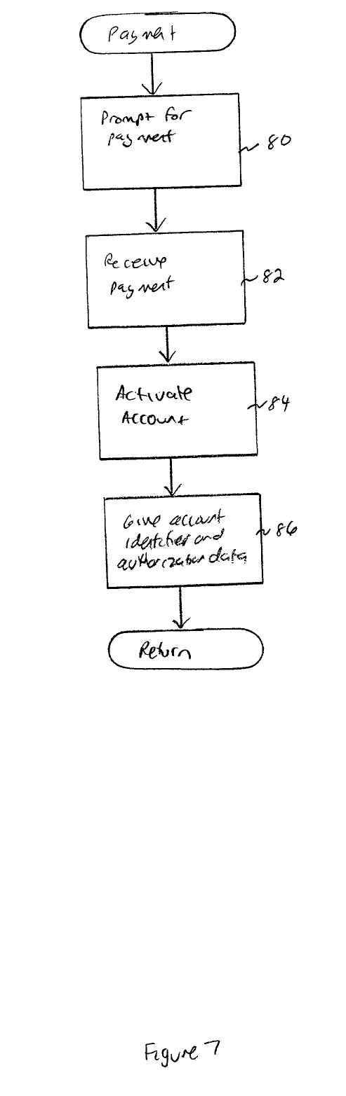

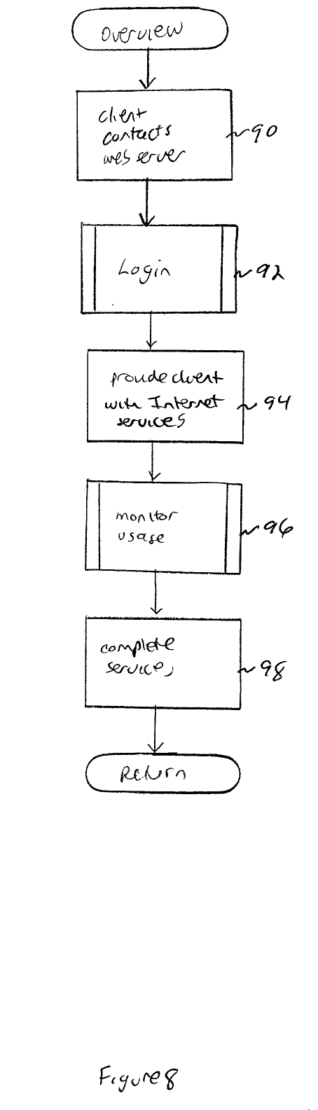

Regardless of the payment scheme, the general pattern of payment and activation of accounts follows the flow chart depicted in FIG. 7. The purchaser will be prompted for payment (step 80 in FIG. 7). The ISP receives payment for the account (step 82 in FIG. 7) and activates the account (step 84 in FIG. 7). The payment may entail transferring electronic currency tokens from a smart card to the ISP. The activation of the account may occur at the time of payment or at the time when a user first attempts to use the account. The activation make the account ready for use by a client. The purchaser is given the account identifier and authorization data (step 86 in FIG. 7). In the illustrative embodiment, the purchaser is given an ISP card that holds the account identifier and is provided with information regarding a PIN or other authorization data. Those skilled in the art will appreciate that third parties may receive payment on behalf of the ISP. Furthermore, third parties may activate the account and tender the ISP card in some embodiments.

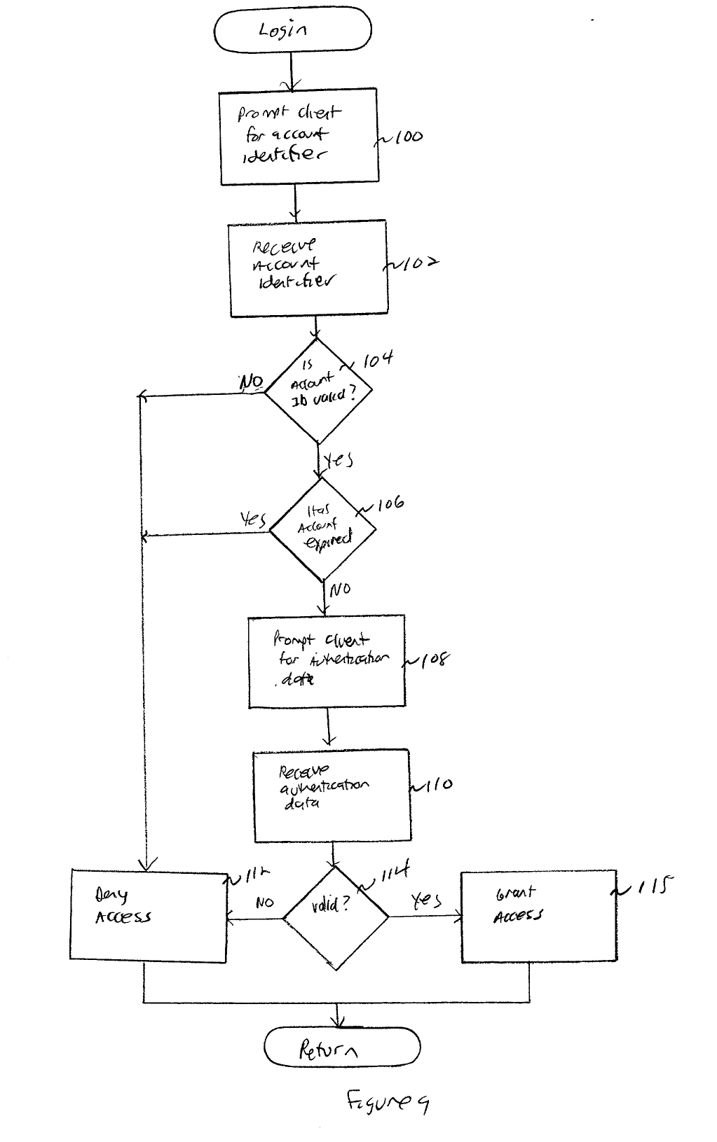

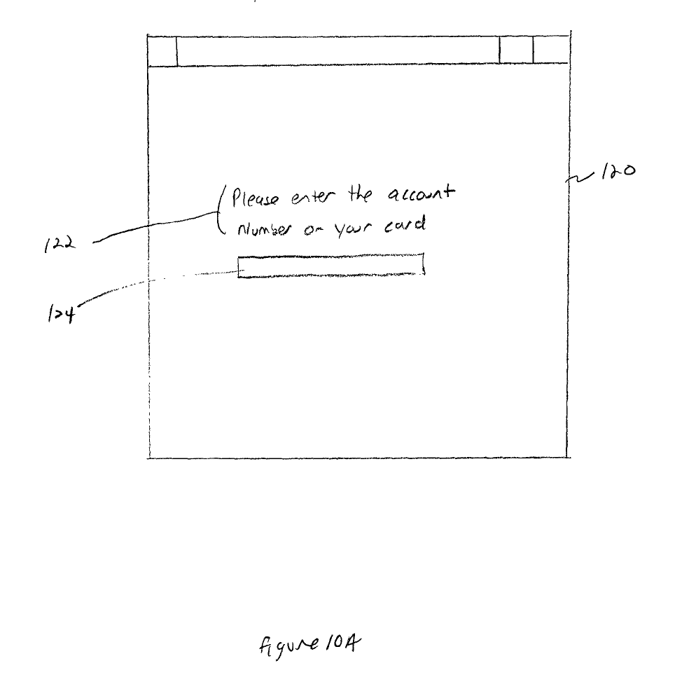

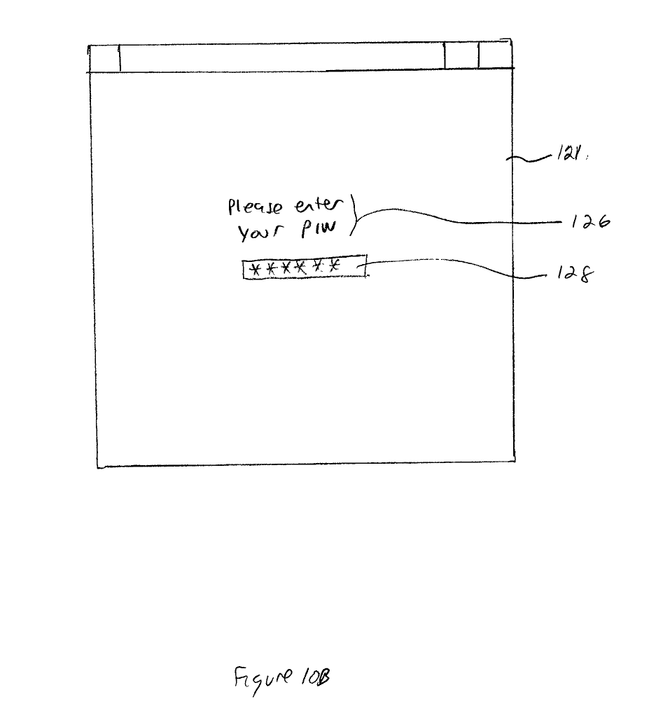

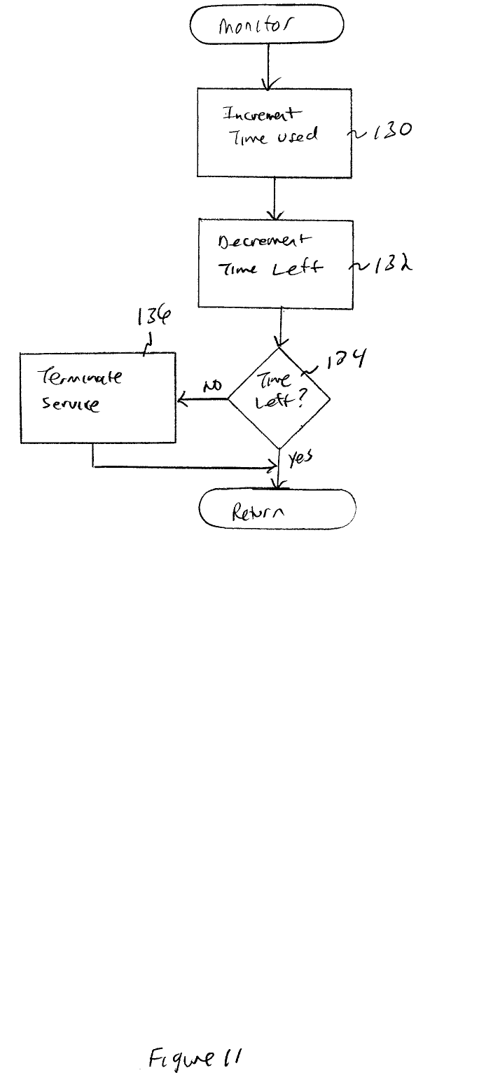

FIG. 8 provides an overview of the steps that are performed for a client to utilize Internet services in the illustrative embodiment. Initially the client contacts the web server 14 (step 90 in FIG. 8). As mentioned above, this may be achieved using dial-up networking software 26 from the client device 12 or by placing a call and using a web browser 28. The client then performs the steps necessary for login (step 92 in FIG. 8). FIG. 9 provides a flow chart of the steps that are performed during login. The login begins with the web server 14 prompting the client for an account identifier, such as an account number (step 100 in FIG. 9). The web server 14 may generate a web page 120, such as shown in FIG. 10A. The web page 120 may be stored as an HTML document on the web server. The web page 120 includes a textual prompt 122 that asks the client to enter an account number for an account within text box 124. The client may type in the account number within the text box 124 and hit a return key so that the account identifier is received by the web server 14 (step 102 in FIG. 9). The web server 14 checks whether the account identifier that is provided by the client is valid or not (step 104 in FIG. 9). The database 42 holds all the valid account identifiers. If the account identifier is not valid, the client is denied access (step 112 in FIG. 9). However, if the account identifier is valid, the web server 14 checks whether the account has expired or not (step 106 in FIG. 9). The accounts may have fixed life cycles such that they expire after a given period of time, or the value of the account may have been totally consumed. For example, an account may be valid for only a single year. Those skilled in the art will appreciate the order of performance of steps 104 and 106 may be reversed. If the account has expired, the client is denied access (step 112 in FIG. 9).

If the account identifier provided by the client is valid, the client is prompted for authentication data (step 108 in FIG. 9). FIG. 10B shows an example of a web page 121 that may provided by the web server 14 to prompt the client to enter authentication data. The web page 121 includes a textual prompt 126. In the example shown in FIG. 10B, the authentication data is a PIN (i.e. a six character alpha-numeric code). The web page 121 may, alternatively, request that the client provide a password or other shared secret that constitutes a type of authentication data. The web page 121 includes a text box 128 in which the authentication data may be entered. The resulting authentication data is received at the web server 14 (step 110 in FIG. 9). The web server 14 checks whether the authentication data is valid or not (step 114 in FIG. 9). If the authentication data is not valid, the client is denied access to the Internet services provided by the ISP via the web server 14. On the other hand, if the authentication data is valid, the client is granted access to the Internet services provided by the ISP via the web server 14 (step 115 in FIG. 9).

Once the client has logged-in to the web server 14 (step 92 in FIG. 8), the web server 14 then provides the client with Internet services (step 94 in FIG. 8). While the client is using the Internet services, the web server 14 monitors usage (step 96 in FIG. 8).

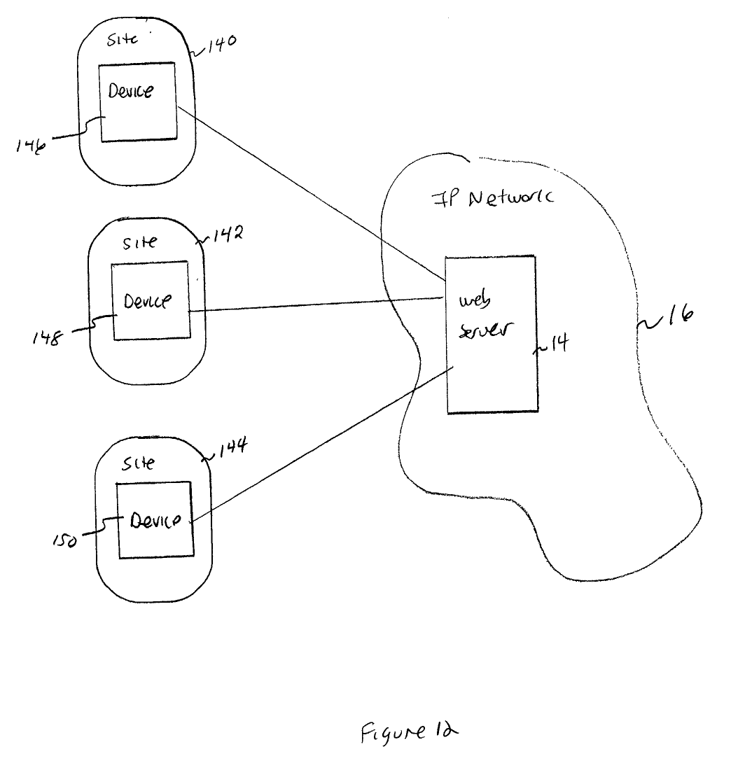

FIG. 11 depicts the steps that are performed to monitor usage of the Internet services by a client (see step 96 in FIG. 8). As was mentioned above, the web server 14 maintains the database 42 to monitor the time used and the time remaining for a given account. The steps shown in FIG. 11 are performed at periodic intervals such as once a minute or once every five minutes. At each interval, the time used for the account is incremented (step 130 in FIG. 11). The time left or remaining for the account is decremented for the same quantity. For example, if the steps are performed every five minutes, in step 130 of FIG. 11, the time used is incremented by 5 minutes and in step 132 of FIG. 11, the time remaining is decremented by 5 minutes. The time usage monitor 44 (see FIG. 3) of the web server 14 then checks whether there is any time remaining for the account in step 134, FIG. 11. If there is not any time left, the client is advised and services are terminated (step 136 in FIG. 11). Otherwise, there is time remaining and the monitoring process continues.

Those skilled in the art will appreciate that the time usage monitor 44 need not wait until no time remains on the account but rather may wait until the account is below a given threshold and give the client warnings. Alternatively, the time usage monitor may actually allow the time to go to slightly negative value and then terminate service at that point. Those skilled in the art will have known a number of different alternatives that may be provided for monitoring such usage. As was mentioned above, the usage need not be monitored purely as a value of time but also may be monitored as a monetary value or as another metric.

Eventually, the client completes usage of the services (step 98 in FIG. 8). The client may subsequently again use the services provided by the web server 14 if time remains on the given account.

The illustrative embodiment need not be practiced with a single client device at a single site as depicted in FIG. 1. Rather mobile users may gain access to the web server 14 from multiple sites, such as depicted in FIG. 12. In that example case, sites 140, 142 and 144 are used to gain access to an account on the web server 14. The client uses different devices (i.e. device 146, device 148 and device 150).

While the present invention has been described with reference to an illustrative embodiment thereof, those skilled in the art will appreciate that various changes in form and detail may be made without departing from the intended scope of the present invention as defined in the appended claims. For example, the present invention need not use an ISP card but rather may simply relay account identifiers and authorization data to clients. The clients may be responsible for retaining such information. Still further, the present invention need not be practiced to gain access to Internet services but more generally may be used to gain access to web services on networks that include the Internet, an intranet or an extranet.

1. In a computer network, a method comprising:
providing an account for access to services that are provided by an Internet service provider (ISP), said account having an associated fixed monetary value;
monitoring a quantity of usage of the account;
debiting the monetary value of the account based on the quantity of usage of the account.

2. The method of claim 1 wherein the method further comprises refusing a user access to the services provided by the ISP when the monetary value of the account is less than a threshold amount.

3. The method of claim 1 wherein the account is not associated with any user.

4. The method of claim 1 further comprising providing a user with a set of information that contains an account identifier and authentication data for use in authenticating the user.

5. The method of claim 4 further comprising authenticating the user.

6. The method of claim 5 wherein authenticating the user entails receiving the account identifier and authentication data from the user.

7. The method of claim 4 further comprising the providing the user with a tangible record of an account identifier for the account.

8. The method of claim 7 wherein the tangible record is a card that is configured to be carried by the user.

9. In a computing environment having a client device for use by a client and a web server for providing web services, a method comprising:
providing a prepaid amount of web services that are available to that client;
enabling the client to use the web services; and
debiting the amount of web services available to the client based on how much the client used the web services.

10. The method of claim 9 wherein the web services are services that provide access by the client to a network.

11. The method of claim 9 wherein the web services are services that provide access by the client to an intranet.

12. The method of claim 9 wherein the client is no longer enabled to use the web services when the amount of web services available to the client has been debited to a point where no amount of web services is available to the client.

13. In a computing environment, a method comprising:
providing a physical object to a user wherein said object includes information regarding a prepaid amount of services provided by an Internet Service Provider (ISP);
receiving a request from the user to access the services provided by the ISP;
receiving at least some of the information included on the physical object from the user; and
in response to receiving at least some of the information on the physical object, providing the services to the user until the prepaid amount of services has been consumed by the user.

14. The method of claim 13 wherein the information included on the physical object includes an account identifier for an account with the ISP.

15. The method of claim 13 wherein the information included on the physical object includes an indication of the prepaid amount of services.

16. The method of claim 13 wherein the physical object is a card.

17. The method of claim 16 wherein the card is a smart card.

18. The method of claim 17 wherein the smart card contains electronic currency of the prepaid amount.

19. The method of claim 18 further comprising paying for the services provided to the user by the ISP by transferring at least some of the electronic currency from the smart card.

20. The method of claim 13 wherein the services comprise Internet access.

21. The method of claim 13 wherein the services comprise access to a remote computing resource.

22. In a computer network, a computer-readable medium containing computer-executable instructions for performing a method, comprising:
providing an account for access to services that are provided by an Internet service provider (ISP), said account having an associated fixed monetary value;
monitoring a quantity of usage of the account; and
debiting the monetary value of the account based on the quantity of usage of the account.

23. The computer-readable medium of claim 22 wherein the method further comprises refusing a user access to the services provided by the ISP when the monetary value of the account is less than a threshold amount.

24. The computer readable medium of claim 22 wherein the account is not associated with any user.

25. The computer-readable medium of claim 22 wherein the method further comprises authenticating a user.

26. In a computing environment having a client device for use by a client and a web server for providing web services, a computer-readable medium containing computer-executable instructions for performing a method comprising:
providing a prepaid amount of web services that are available to the client;
enabling the client to use the web services; and
debiting the amount of web services available to the client based on how much the client used the web services.

27. The computer-readable medium of claim 26 wherein the web services are services that provide access by the client to a network.

28. The computer-readable medium of claim 26 wherein the web services are services that provide access by the client to an intranet.

29. The computer-readable medium of claim 26 wherein the client is no longer enabled to use the web services when the amount of web services available to the client has been debited to a point where no amount of web services is available to the client.

30. In a computing environment, a method, comprising:
providing an account for access to services that are provided by a service provider, wherein said account has an associated fixed time value and is not associated with a user;
enabling a requester to access the services via the account; and
debiting the fixed time value by an amount of time that the requester accesses the Internet services via the account.

31. In a distributed environment having multiple login sites where a user may login, a method comprising:
providing a web services account for web services, wherein said account is authorized for a fixed amount of web services;
enabling a user to access the web services via the account from a first of the login sites; and
enabling a user to access the web services via the account from a second of the login sites.

32. The method of claim 31 further comprising debiting the amount of web services for which the account is authorized based on a duration of access by the user.

33. The method of claim 31 wherein the debiting is performed at a constant rate based upon duration of access by the user.

34. The method of claim 31 wherein the user uses a first device to access the web services at the first login site and a second device to access the web services at the second login device and wherein the first device differs from the second device.

35. In a computing environment, a computer readable medium holding computer-executable instructions for performing a method, comprising:
providing an account for access to services that are provided by a service provider, wherein said account has an associated fixed time value and is not associated with a user;
enabling a requester to access the Internet services via the account; and
debiting the fixed time value by an amount of time that the requester accesses the Internet services via the account.

36. In a distributed environment having multiple login sites where a user may login, a computer readable medium holding computer-executable instructions for performing a method, comprising:
providing a web services account for web services, wherein said account is authorized for a fixed amount of web services;
enabling a user to access the web services via the account from a first of the login sites; and
enabling a user to access the web services via the account from a second of the login sites.

37. The computer-readable medium of claim 36 wherein the method further comprises debiting the amount of web services for which the account is authorized based on a duration of access by the user.

38. The computer-readable medium of claim 36 wherein the debiting is performed at a constant rate based upon duration of access by the user.

39. In a computer network, a transmission medium for transmitting instructions for performing a method comprising:
providing an account for access to Internet services that are provided by an Internet service provider (ISP), said account having an associated fixed monetary value;
monitoring a quantity of usage of the account; and
debiting the monetary value of the account based on the quantity of usage of the account.

40. The transmission medium of claim 39 wherein the method further comprises refusing a user access to the Internet services provided by the ISP when the monetary value of the account is less than a threshold amount.

41. The transmission medium of claim 39 wherein the account is not associated with any user.

42. In a computing environment having a client device for use by a client and a web server for providing web services, a transmission medium for transmitting instructions for performing a method comprising:
providing a prepaid amount of web services that are available to the client;
enabling the client to use the web services; and
debiting the amount of web services available to the client based on how much the client used the web services.

43. The transmission medium of claim 42 wherein the web services are services that provide access by the client to the Internet.

44. The transmission medium of claim 42 wherein the web services are services that provide access by the client to an intranet.

45. A computer network, comprising:
means for providing an account for access to Internet services that are provided by an Internet service provider (ISP), said account having an associated fixed monetary value;
means for monitoring a quantity of usage of the account; and
means for debiting the monetary value of the account based on the quantity of usage of the account.

46. The computer network of claim 45 further comprising means for refusing a user access to the Internet services provided by the ISP when the monetary value of the account is less than a threshold amount.

47. A computer system, comprising
a web service provider for providing web services to clients;
an account manager for creating accounts for accessing the web services provided by the web service provider, wherein each account is allocated a prepaid fixed amount of the web services; and
a monitor for monitoring usage of the accounts and debiting the accounts based on usage.

48. The computer system of claim 47 wherein the manager includes a database of account information for the accounts.

49. The computer system of claim 47 wherein the account information includes data regarding usage of the accounts.
